(19) United States
(12) Patent Application Publication
(10) Pub. No.: US 2022/0146908 A1
(43) Pub. Date: May 12, 2022

(54) FOCUSING DEVICE AND PHOTOGRAPHIC APPARATUS

(71) Applicant: IVIEW DISPLAYS (SHENZHEN) COMPANY LTD., Shenzhen (CN)

(72) Inventors: Liang Mei, Shenzhen (CN); Steve Yeung, Hong Kong (CN); Zhiqiang Gao, Hong Kong (CN); Mingnei Ding, Shenzhen (CN); Yuan Zhao, Shenzhen (CN)

(21) Appl. No.: 17/584,480

(22) Filed: Jan. 26, 2022

Related U.S. Application Data
(63) Continuation of application No. PCT/CN2019/129518, filed on Dec. 28, 2019.

(30) Foreign Application Priority Data
Jul. 29, 2019 (CN) 201921220945.9

(51) Int. Cl. G03B 13/34; G03B 17/12; H04N 5/225

(52) U.S. Cl. CPC G03B 13/34; H04N 5/2254; G03B 17/12

(57) ABSTRACT

The present disclosure provides a focusing device and a photographic apparatus. The focusing device includes a lens assembly, a first motor, a second motor, and a motor control board. The lens assembly includes a lens. The first motor and the second motor are respectively disposed on two opposite sides of the lens assembly. The motor control board is fixedly disposed on a side of the lens assembly, and controls the two motors to rotate, such that the first motor and the second motor drive the lens to move.

### CROSS-REFERENCE TO RELATED APPLICATIONS

This application is a continuation-application of International (PCT) Patent Application No. PCT/CN2019/129518, filed on Dec. 28, 2019, which claims priority to Chinese Patent Application No. 201921220945.9, filed with the National Intellectual Property Administration of China on Jul. 29, 2019, and entitled “FOCUSING DEVICE”, the entire contents of which are incorporated herein by reference.

### TECHNICAL FIELD

The present disclosure relates to the technical field of lens, and in particular, relates to a focusing device and a photographic apparatus.

### BACKGROUND

With constant developments of digital technologies, electronic technologies have been extensively applied to the field of cameras, digital imaging technologies gain rapid developments, cameras are more and more smart, and cameras are being designed towards miniaturization.

A traditional camera generally employs a large-sized motor which is disposed on a side of the lens, and thus the entire apparatus has a greater thickness. During movement, due to insufficient push force of the motor, the lens may be imbalanced during movement, thereby causing inclinations.

### SUMMARY

An embodiment of the present disclosure provides a focusing device. The focusing device includes: a lens assembly, including a lens; a first motor and a second motor, respectively disposed on two opposite sides of the lens assembly; and, a motor control board, fixedly disposed on a side of the lens assembly, and configured to control the first motor and the second motor to rotate, such that the first motor and the second motor drive the lens to move.

Another embodiment of the present disclosure provides a photographic apparatus including: a lens assembly, comprising a lens; a first motor and a second motor, respectively disposed on two opposite sides of the lens assembly; wherein the first motor and the second motor are configured to synchronously drive the lens to move; and, two motor supports, respectively disposed on two opposite sides of the lens assembly; wherein the two motor supports are fixedly connected to the lens assembly via a connection member.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic structural exploded view of a focusing device according to an embodiment of the present disclosure.

FIG. 2 is a schematic overall structural diagram of a focusing device according to an embodiment of the present disclosure.

### DETAILED DESCRIPTION

For better understanding of the present disclosure, the present disclosure is described in detail with reference to attached drawings and specific embodiments. It should be noted that, when an element is defined as “being fixedly disposed on” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “upper,” “lower,” “inner,” “outer,” “vertical,” “horizontal,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first,” “second,” and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

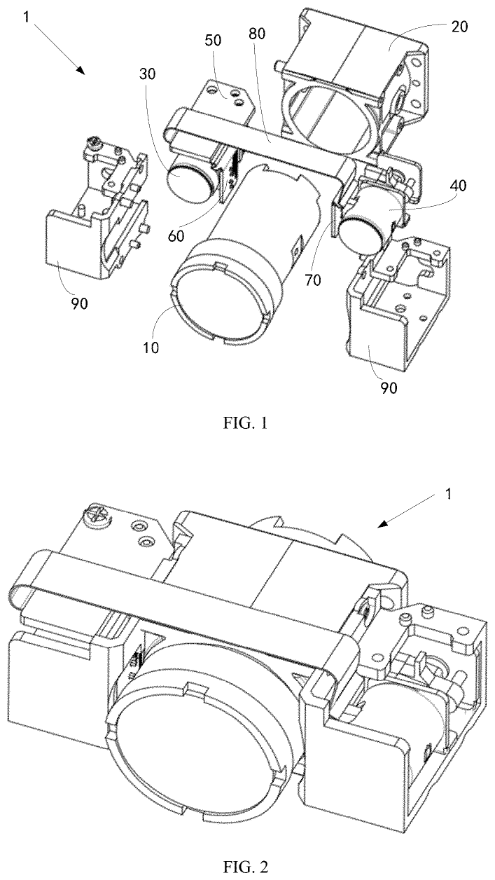

Referring to FIG. 1 and FIG. 2, a focusing device 1 according to an embodiment of the present disclosure is applicable to a photographic apparatus such as a digital camera, a smart camera, a single-eye camera, and the like. However, practical application of the focusing device is not limited to the photographic device. An embodiment of the present disclosure provides a focusing device 1. The focusing device 1 includes a lens assembly, a first motor 30, a second motor 40, and a motor control board 50, wherein the lens assembly includes a lens 10.

In an embodiment of the present disclosure, the lens 10 may be an optical lens (for example, a 180-mm macro optical lens from Canon). Such an optical lens is capable of receiving an optical object and adjusting the same, thereby achieving optical imaging. The optical lens may be a short-focus lens, a middle-focus lens, or a long-focus lens in terms of a focal length; the optical lens may be a wide-angle lens, a standard lens, or a telephoto lens in terms of a magnitude of a field of view; and the optical lens may be a fixed-aperture fixed-focus lens, a manual-aperture fixed-focus lens, an automatic-aperture fixed-focus lens, a manual focusing lens, an automatic-aperture motorized zoom lens, a motorized zoom lens, or the like in terms of structure. The lens 10 may be made of a material that is partially or completely reflective or penetrative. Typically, the material includes glass or plastic. During taking an image by the optical lens, a side, proximal to an object to be shot, on a light path is an enlargement side, and a side, proximal to a photosensitive element, on the light path is a reduction side. It may be understood that in some other embodiments, the lens 10 may be other ordinary lens. It should be noted that the lens 10 is a lens well known to a person skilled in the art, and has all the functions of the lens. A suitable lens may be selected according to actual needs, and the lens is not limited to that described in this embodiment.

The first motor 30 and the second motor 40 are devices configured to supply power to the lens 10, which may be ultrasonic wave motors (USMs). The first motor 30 and the second motor 40 are respectively disposed on two opposite sides of the lens assembly. Specifically, the first motor 30 is disposed on a left side of the lens assembly, the second motor 40 is disposed on a right side of the lens assembly, and the first motor 30 and the second motor 40 have the same size and shape, such that an identical rotation rate is supplied. In some other embodiments, the first motor 30 may be disposed on the right side of the lens assembly, and the second motor 40 may be disposed on the left side of the lens assembly, as long as one motor is disposed on each of the two opposite sides of the lens assembly. It should be noted that the left side and the right side are defined merely for illustration instead of limitation.

The motor control board 50 is fixedly disposed on a side of the lens assembly, and the motor control board 50 is provided with a control chip and a position sensor. The control chip may be an MSP430G2433 control chip, and the position sensor may be any sensor manufactured by Omron, which is capable of sensing a position of an object under detection and converting the position into a useful output signal. The motor control board 50 triggers, in response to a signal fed back by the position sensor, the control chip to control the first motor 30 and the second motor 40 to rotate synchronously. The first motor 30 and the second motor 40 have the same size and shape, such that under control of the motor control board 50, the first motor 30 and the second motor 40 have a consistent rotation speed. In this way, the first motor 30 and the second motor 40 drive the lens 10 to be subjected to a doubled push force due to symmetry of axial center, and thus the lens moves. In addition, the lens is prevented from swinging.

In some embodiments, the motor control board 50 and the first motor 30 are disposed on a same side of the lens assembly. Specifically, the motor control board 50 and the first motor 30 are disposed on the left side of the lens assembly. In some other embodiments, the motor control board 50 and the first motor 30 are disposed on the right side of the lens assembly, or the motor control board 50 and the second motor 40 are disposed on the same side of the lens assembly. Such configurations may be designed according to actual needs.

In some embodiments, the focusing device 1 further includes a first circuit board 60, a second circuit board 70, and a flex cable 80. The first circuit board 60 and the second circuit board 70 are flexible circuit boards, and a model of the circuit boards is P/N: 0007-000, IPD832MH MOTOR FPC. The motor control board 50 is electrically connected to the first motor 30 via the first circuit board 60. The second circuit board 70 is electrically connected to the second motor 40. An end of the flex cable 80 passes through the motor control board 50 and is electrically connected to the motor control board 50 and the first circuit board 60, and the other end of the flex cable 80 is electrically connected to the second circuit board 70. That is, the motor control board 50 triggers, in response to a signal fed back by the position sensor, the control chip to send a control signal such that the first circuit board 60 controls the first motor 30 to rotate, and meanwhile, the control signal is transmitted to the second circuit board 70 via the flex cable 80 such that the second circuit board 70 controls the second motor 40 to rotate. By using the same feedback signal, the first motor 30 and the second motor 40 are synchronously controlled to drive the lens 10 to be subjected to a doubled push force due to symmetry of axial center, such that the lens moves. In this way, it is ensured that the lens 10 remains stable during movement, without any inclination.

It may be understood that in some other embodiments, the control chip and the position sensor may be directly disposed on the first circuit board 60 and the second circuit board 70, the first circuit board 60 and the second circuit board 70 are connected via an electric wire, the first circuit board 60 and the first motor 30 are electrically connected, and the second circuit board 70 and the second motor 40 are electrically connected. Specifically, the first circuit board 60 and the second circuit board 70 are both provided with the control chip and the position sensor. Based on the signal fed back by the position sensor, the control chip on the first circuit board 60 is triggered to control the first motor 30 to rotate; and meanwhile, the control chip on the second circuit board 70 is triggered to control the second motor 40 to rotate. By using the same feedback signal, the control chips on different circuit boards control different motors to synchronously rotate, such that the lens 10 is subjected to the doubled push force due to symmetry of axial center. In this way, it is ensured that the lens 10 remains stable during movement. It should be noted that the control chip and the position sensor disposed on the first circuit board 60 are consistent with the control chip and the position sensor disposed on the second circuit board 70 in terms of model. The chip and sensor are those well known in the art.

In some embodiments, the focusing device 1 further includes two motor supports 90. The two motor supports 90 are made of a rigid material, for example, metals, and thus achieve a good support force. The two motor supports 90 are respectively disposed on two opposite sides of the lens assembly. That is, the two motor supports 90 are respectively disposed on the left side and the right side of the lens assembly, and are connected to the lens assembly via screw fastener members. The two motor supports 90 are each provided with a receiving space, wherein the first motor 30, the first circuit board 60, and the motor control board 50 are all received in the receiving space of one of the motor supports 90 and are fixed via screws. The second motor 40 and the second circuit board 70 are received in the receiving space of the other of the motor supports 90 and are fixed via screws. The shape and size of the motor support 90 are determined by the shape and size of the motor control board 50. However, the two motor supports 90 need to have identical size and shape.

In some embodiments, the focusing device 1 further includes a lens sleeve 20, wherein the two motor supports 90 are fixed onto the lens sleeve 20. Specifically, the two motor supports 90 are respectively fixed to left and right sides of the lens sleeve 20 via screw fastener members. The lens sleeve 20 is made of a rigid material, and thus achieves a support force and facilitates shaping. The lens sleeve 20 is a hollow cuboid, and the lens 10 may be received in the lens sleeve 20. In some other embodiments, the lens sleeve 20 may be in other shapes or made of other materials. For example, the lens sleeve 20 is circular, and the lens sleeve 20 may be made of soft plastic. Therefore, the lens sleeve 20 is flexible and is thus bendable.

As compared with the related art, the present disclosure achieves the following beneficial effects. Different from the related art, in the focusing device according to the embodiments of the present disclosure, a motor is disposed on each of two opposite sides of the lens assembly, the motor control board is fixedly disposed on a side of the lens assembly, and controls the two motors disposed on the two sides of the lens assembly to synchronously rotate to increase a push force of the motor such that the lens remains stable during movement and inclination is prevented. In addition, two small motors may effectively reduce the entire size of the device.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A focusing device, comprising:
a lens assembly, comprising a lens;
a first motor and a second motor, respectively disposed on two opposite sides of the lens assembly; and
a motor control board, fixedly disposed on a side of the lens assembly, and configured to control the first motor and the second motor to rotate, such that the first motor and the second motor drive the lens to move.

2. The focusing device according to claim 1, wherein the motor control board and the first motor are disposed on a same side of the lens assembly.

3. The focusing device according to claim 2, further comprising:
a first circuit board, a second circuit board, and a flex cable;
wherein the motor control board is electrically connected to the first motor via the first circuit board, the second circuit board is electrically connected to the second motor, an end of the flex cable is electrically connected to the first circuit board, and the other end of the flex cable is electrically connected to the second circuit board.

4. The focusing device according to claim 3, wherein the first circuit board and the second circuit board are flexible circuit boards.

5. The focusing device according to claim 4, further comprising:
two motor supports;
wherein the two motor supports are respectively disposed on two opposite sides of the lens assembly, and the two motor supports are fixedly connected to the lens assembly via a connection member.

6. The focusing device according to claim 5, wherein the two motor supports are connected to the lens assembly via screw fastener members.

7. The focusing device according to claim 6, wherein the two motor supports are each provided with a receiving space, wherein the first motor, the first circuit board, and the motor control board are all received in the receiving space of one of the motor supports, and the second motor and the second circuit board are received in the receiving space of the other of the motor supports.

8. The focusing device according to claim 7, wherein the lens assembly further comprises a lens sleeve, and the two motor supports are fixed onto the lens sleeve.

9. The focusing device according to claim 8, wherein the lens sleeve is a hollow cuboid.

10. The focusing device according to claim 9, wherein the lens is an optical lens.

11. A photographic apparatus, comprising:
a lens assembly, comprising a lens;
a first motor and a second motor, respectively disposed on two opposite sides of the lens assembly; wherein the first motor and the second motor are configured to synchronously drive the lens to move; and
two motor supports, respectively disposed on two opposite sides of the lens assembly; wherein the two motor supports are fixedly connected to the lens assembly via a connection member.

12. The photographic apparatus according to claim 11, further comprising:
a motor control board, fixedly disposed on a side of the lens assembly, and configured to control the first motor and the second motor to rotate, such that the first motor and the second motor drive the lens to move.

13. The photographic apparatus according to claim 12, wherein the motor control board and the first motor are disposed on a same side of the lens assembly.

14. The photographic apparatus according to claim 13, further comprising:
a first circuit board, a second circuit board, and a flex cable;
wherein the motor control board is electrically connected to the first motor via the first circuit board, the second circuit board is electrically connected to the second motor, an end of the flex cable is electrically connected to the first circuit board, and the other end of the flex cable is electrically connected to the second circuit board.

15. The photographic apparatus according to claim 14, wherein the first circuit board and the second circuit board are flexible circuit boards.

16. The photographic apparatus according to claim 15, wherein the two motor supports are connected to the lens assembly via screw fastener members.

17. The photographic apparatus according to claim 16, wherein the two motor supports are each provided with a receiving space, wherein the first motor, the first circuit board, and the motor control board are all received in the receiving space of one of the motor supports, and the second motor and the second circuit board are received in the receiving space of the other of the motor supports.

18. The photographic apparatus according to claim 17, wherein the lens assembly further comprises a lens sleeve, and the two motor supports are fixed onto the lens sleeve.

19. The photographic apparatus according to claim 18, wherein the lens sleeve is a hollow cuboid.

20. The photographic apparatus according to claim 19, wherein the lens is an optical lens.
